(19) United States
(12) Patent Application Publication
(10) Pub. No.: US 2015/0145368 A1
(43) Pub. Date: May 28, 2015

(54) Rotor Support for an Electrical Machine, Support Element for a Rotor Support and Method of Producing a Support Element

(71) Applicant: Daimler AG, Stuttgart (DE)

(72) Inventors: Martin Doeringer, Suessen (DE); Manfred Kempf, Vogt (DE); Hans-Guenther Merheim, Uhingen (DE)

(73) Assignee: Daimler AG, Stuttgart (DE)

(21) Appl. No.: 14/396,642

(22) PCT Filed: Jan. 29, 2013
(86) PCT No.: PCT/EP2013/000258

§ 371 Date: Oct. 23, 2014

(30) Foreign Application Priority Data
Apr. 24, 2012 (DE) 10 2012 008 016.6

(51) Int. Cl. H02K 1/30; H02K 1/27; H02K 15/14

(52) U.S. Cl. CPC H02K 1/30; H02K 15/14; H02K 1/27
USPC 310/156.12; 29/596

(57) ABSTRACT

A rotor arm for an electrical machine having a support pot, which includes a hub for the mounting of a drive shaft, for mounting at least one magnetic element is provided. The rotor arm includes a supporting disk arranged on a support pot at a distance axially from the hub. The supporting element has a passage aligned with the hub for mounting the drive shaft.

### BACKGROUND AND SUMMARY OF THE INVENTION

Exemplary embodiments of the invention relate to a rotor arm for an electrical machine, a supporting element for a rotor arm according, and a method for the production of a supporting element.

Rotor arms for electrical machines are known. An electrical machine has a stator and a rotor, assembled for rotation within it, wherein an electromagnetic coupling between rotor and stator can be produced that ensures either that electrical energy supplied to the electrical machine is converted into mechanical energy, or that mechanical energy supplied to the electrical machine is converted into electrical energy. The electrical machine therefore operates either as a motor or as a generator. Therein, it is possible that the same electrical machine, depending on the operating type, is used both as a motor and as a generator. For example, this is known from the automobile sector, in particular for hybrid vehicles or purely electrically driven vehicles, where it is possible that the same electrical machine as a motor converts electrical power into driving power, wherein it can regain braking energy in another operating status by way of so-called recuperation and convert it into electrical energy. The rotor of an electrical machine typically comprises a rotor arm having a support pot, which serves for the mounting of at least one magnetic element. The magnetic element is preferably formed as a stack of sheets, which, depending on the operational mode or the design of the electrical machine, is provided with at least one electrical winding or at least one permanent magnet. Several windings or permanent magnets are preferably provided—seen in the peripheral direction—at constant angular distance from one another. The at least one magnetic element can be provided on an outer peripheral wall of the support pot or also on an inner wall of the same. The support pot has a hub for mounting a drive shaft.

German patent document DE 20 2006 019 091 U1 discloses a rotor arm for an electrical motor in which a rotor axle shaft is pressed into a bearing formation, in particular a hub. Alternatively it is possible that the drive shaft is assembled rotatably in the hub, wherein it can be connected non-rotatably to the rotor arm with the aid of a clutch. In any case, the drive shaft in known rotor arms is supported on one side in the region of the hub. This causes a slight imbalance in the region of the system made from drive shaft and rotor arm and in particular a slight tilting of the drive shaft relative to the rotor arm results in no constant gap between the rotor and the stator—seen in the peripheral direction and also in the axial direction. This also results, in particular, in connection with an imbalance occurring more strongly with increasing rotational speed, to considerable performance losses of the electrical machine, which can amount to 30% or more of the power rating. Furthermore, a very precise manufacturing due to the single-side mounting of the drive shaft in the region of the hub is not possible such that considerable performance fluctuations of individual electrical machines result in series manufacture.

Exemplary embodiments of the invention are therefore directed to a rotor arm, a supporting element for a rotor arm, as well as a method for the production of a supporting element, wherein the named disadvantages, and in particular an imbalance that reduces the performance of the electrical machine, are clearly reduced, preferably is prevented.

The rotor arm is characterized by a supporting element arranged on the support pot at a distance axially from the hub, wherein it has a passage that is aligned with the hub for mounting the drive shaft. The drive shaft is therefore not exclusively mounted in the region of the hub, but in a further position at a distance axially from the hub, in particular in the passage of the supporting element that is aligned with the hub. This results in an improved support of the drive shaft such that an imbalance is clearly reduced, preferably completely prevented. Thus, performance losses of the electrical machine are clearly reduced, and also a series variation of the performance of individual electrical machines in the series is clearly reduced.

The supporting element is preferably formed as a supporting disk. Alternatively, it is possible that the supporting element is formed to be star-shaped. The rotor arm is preferably formed as a rotor arm of an electrical machine for a motor vehicle. Therein the electrical machine is preferably provided for use in a hybrid vehicle or in an electrically operated vehicle.

A rotor arm is preferred that is characterized in that a bearing is mounted in the passage. Preferably the bearing is pressed into the passage. Particularly preferably, the bearing is formed as a rolling bearing. In the case of such an exemplary embodiment, the drive shaft is mounted rotatably in the passage relative to the rotor arm. Therein, preferably, it is also mounted rotatably in the hub of the support pot, preferably in a rolling or needle bearing. The drive shaft is therefore mounted rotatably as whole relative to the rotor arm. In order to be able to transfer a torque from the rotor arm to the drive shaft, preferably a clutch is provided in the support pot, preferably a multi-plate clutch. This can be closed in order to ensure a non-rotatable coupling between the drive shaft and the rotor arm. The transfer of torque between the rotor arm and the drive shaft can be varied via abrasively closing clutch states.

It is possible for the drive shaft to be formed as one piece. In another exemplary embodiment, the shaft is formed in multiple pieces. Particularly preferably, it comprises a drive-side and an output-side shaft element, wherein the shaft elements are not connected to one another or are only able to be brought into operative connection with one another via the clutch. In this case, in a known electrical machine, typically only the drive-side shaft element is mounted in the hub of the support pot, while the output-side shaft element is mounted, for example in the electrical machine or in a gear allocated to the electrical machine. An exact coaxial alignment of the two shaft elements relative to each other and relative to the support pot cannot then be ensured or only with difficulty. In contrast, in the case of the rotor arm addressed here, the drive shaft, in addition to the mounting in the hub, is also mounted in the passage of the supporting element aligned with this. Preferably, the drive-side shaft element is mounted in the hub, while the output-side shaft element is mounted in the passage of the supporting element. Thus it is possible, to ensure an exact coaxial alignment of the two shaft elements relative to each other and relative to the rotor arm and thus overall to ensure a coaxial arrangement of the drive shaft relative to the rotor arm. Also in this case, the drive shaft is therefore not exclusively mounted in the region of the hub, but also in a further position at a distance axially from the hub, in particular in the passage of the supporting element which is aligned with the hub. It is also possible for the drive shaft to have a rolling or needle bearing, in which the drive shaft is mounted rotatably, for example, by means of a pivot. The coaxial alignment is additionally secured in this way. An inverted embodiment is of course also possible, in which the drive shaft is mounted rotatably in a rolling or needle bearing of the output shaft.

Preferably it is possible that the clutch is also mounted both in the region of the hub of the support pot and in the passage of the supporting element. Therein, the clutch is preferably non-rotatably connected, for example by means of a plug-in toothing, to the hub of the support pot. It is possible that it is fixed at the same time to a base of the support pot. Therefore, a fixed bearing is provided in this region. In an exemplary embodiment, the clutch is free, so not mounted, on one opposing end—seen in the axial direction. While this is not problematic for smaller electrical machines, in the case of larger electrical machines, in particular in the case of electrical machines generating high torques, oscillations and/or imbalances can occur in the region of the clutch. Therefore the coupling is also preferably mounted in the passage of the supporting element, wherein here, preferably, a mounting that is rotatable relative to the supporting element is provided, preferably in a rolling or needle bearing.

Finally, a bearing is preferably also provided in the region of the hub of the support pot for mounting the support pot itself in a housing of the electrical machine, a gear housing or in another suitable manner. This bearing can also be formed as a rolling or needle bearing or fixed bearing.

The named bearings are preferably formed as radial bearings. Preferably, at least one of the named bearings is also formed at the same time as an axial bearing. Particularly preferably, all of the bearings addressed here are formed as both axial and radial bearings.

A rotor arm is also preferred which is characterized in that the supporting element is arranged on an end of the support pot facing away from the hub. Therein, preferably, the hub itself is arranged on a first end of the support pot, such that the supporting element and the hub are arranged on opposing ends—seen in the axial direction—of the support pot. An imbalance can thus be particularly effectively prevented because as large a distance as possible is provided between the supporting locations of the drive shaft and preferably also of the clutch on the rotor arm.

A rotor arm is also preferred which is characterized in that the support pot has an end stop for the supporting element preferably formed as a recess on an inner peripheral surface. The end stop formed as a recess is preferably formed as a layered recess, on which the supporting element is mounted.

The support pot comprises—seen in the axial direction—a substantially constant inner diameter, which increases in the region of the recess—on a side of the same facing away from the hub— such that a ledge is formed here. The ledge is preferably formed to be circulating—seen in the peripheral direction—and the supporting element is abuts onto the ledge in the assembled state. Thus, the supporting element is able to be applied as a whole on the end stop in a stable manner.

It is also possible that the end stop comprises more than one, preferably three recesses and/or protrusions, which particularly preferably are arranged at the same angular distance from one another—seen in the peripheral direction. Therein they are preferably arranged at the same high at one another—seen in the axial direction. A stable attachment of the supporting element to the end stop is also possible in this way.

Preferably, a through bore is provided in a peripheral wall of the support pot at the height of the supporting element—seen in the axial direction—, through which a securing means is able to be guided, which engages in a receiving recess of the supporting element, the receiving recess being provided in a peripheral surface of the same. It is thus possible to fix the supporting element in a pre-determined rotational position—seen in the peripheral direction—relative to the support pot. Fundamentally, it is preferable that the supporting element is pinned or screwed together in the region of its periphery, in particular by means of a single pin or of a single screw, as a securing means. Therein, a releasable connection ensures a simple exchangeability and/or disassembly of the supporting element.

Alternatively or additionally it is possible that the supporting element is connected to the support pot, in particular after the pinning or screwing together, in particular soldered, welded and/or adhered. In another exemplary embodiment, it is also possible that the supporting element is pressed into the support pot instead of screwing or pinning.

In order to also fix the supporting element fixed in the peripheral direction in the axial direction, preferably—seen in the axial direction—an annular groove is provided in the inner peripheral surface of the support pot at a distance from the end stop, in which inner peripheral surface a fixing means is able to be arranged for the axial fixing of the supporting element. The fixing element is preferably formed as a snap ring. Therein, an axial distance to the annular groove from the end stop is preferably selected such that it corresponds approximately to a thickness of the supporting element, which is then preferably fixed axially by pre-tensioning or clamping between the end stop and the fixing means arranged in the annular groove.

Generally, an axial direction here refers to a direction that is arranged in parallel to a symmetry axis of the preferably cylindrically symmetrical rotor of the electrical machine. A peripheral direction is a direction which concentrically encloses the symmetry axis. A radial direction is a direction which is perpendicular to the axial direction.

Preferably, a further bearing location for the drive shaft formed in one or several pieces is provided for further reinforcement. For this purpose, preferably an additional supporting element is connected positively, non-positively and/or firmly to the support pot and/or to the supporting disk, the additional supporting element preferably being formed as a cover plate and in which the drive shaft is mounted. The additional supporting element is preferably arranged—seen in the axial direction —, seen relative to the hub of the support pot, on the side of the supporting element, however at a larger axial distance from the hub than this. Preferably, it has a bearing, in particular a rolling or needle bearing, for the rotatable mounting of the drive shaft.

It is possible that the additional supporting element or the cover plate abuts directly on the supporting element. In such an exemplary embodiment, the supporting element is therefore initially placed on the end stop, wherein then the additional supporting element is placed on the supporting element. Finally it is possible to fix both elements by means of a fixing means arranged in an annular groove, preferably a snap ring. The distance of the annual groove from the end stop is then preferably selected such that it corresponds approximately to the sum of the thickness of the supporting element as well as of the additional supporting element, such that ultimately, both elements are fixed by pre-stressing or clamping between the end stop and the fixing means arranged in the annular groove.

With the aid of the additional supporting element, it is possible to implement a three-point bearing for a one-piece drive shaft, such that this is mounted very stably. If the shaft is formed in several parts, and if it comprises preferably a drive-side and an output-side shaft element, preferably the drive-side shaft element is mounted both in the supporting element and in the additional supporting element such that a two-point bearing is able to be implemented for this shaft element. Hereby, overall a very stable mounting of the drive shaft is also achieved wherein a coaxiality to the rotor arm can be ensured.

Exemplary embodiments are also directed to a supporting element for a rotor arm that is characterized by a central passage provided for the mounting of the drive shaft. The supporting element is preferably formed as a supporting disk or alternatively to be star-shaped. The central passage enables a second supporting position for the drive shaft beyond the hub of the support pot, such that imbalances, which otherwise lead to a considerable performance loss of the electrical machine, in which the supporting element is provided, are effectively prevented. The advantages result in this respect, which were already discussed in connection with the rotor arm.

Preferably the supporting element also has a bearing for the clutch such that this is also able to be mounted stably, preventing oscillations and/or imbalances and in particular coaxially to the support pot or to the rotor arm.

Preferably, at least one bearing is arranged, preferably pressed, in the passage, in particular a rolling or needle bearing, in which the drive shaft is mounted rotatably relative to the supporting element. Particularly preferably, a further bearing is arranged, preferably pressed, in the passage, in particular a rolling or needle bearing, in which according to the operational state of the clutch, the clutch is mounted rotatably relative to the supporting element.

A supporting element is preferred that is characterized in that a receiving recess is provided in a peripheral surface of the same, the receiving recess serving as the non-rotatable fixing of the supporting element on the support pot. A securing means that engages through a through bore provided in a peripheral wall of the support pot can engage in the receiving recess in order to ensure the non-rotatable fixing of the supporting element on the support pot. Therein it is possible that the receiving recess is formed as a cylindrical bore or receiving hole. In this case, the securing means ensures an axial securing of the supporting element at the same time. Preferably, however, it is provided for the compensation of production tolerances that the receiving recess is provided as a groove—running in the axial direction—such that the securing means only ensures a non-rotatable fixing of the supporting element on the support pot. An additional axial fixing can then—as has already been described—be ensured with the aid of a fixing means, preferably a snap ring.

A supporting element is also preferred that is characterized by at least one retaining element for a rotation locator. Therein the retaining element is preferably formed as a coil enclosing the central passage particularly preferably concentrically at a pre-determined distance—seen in the radial direction. Alternatively it is possible that the retaining element comprises a segment of a coil and/or that—preferably at the same angular distance from one another—at least two, preferably three coil segments are provided as retaining elements. The rotation locator is preferably formed as an inductively acting rotation locator. Particularly preferably, the retaining element is formed such that the rotation location is able to be inserted onto this. Preferably, the retaining element has a fixing means serving as the non-rotatable positioning of the rotation locator. It is possible that the fixing means is formed as a slot—preferably extending in the axial direction—in which a blocking element of the rotation locator is able to be inserted. In this way, a predetermined relative position—seen in the peripheral direction—is able to be fixed between the supporting element and the rotation locator.

A supporting element is also preferred that is characterized by at least one oil guiding element as well as at least one oil passage bore, wherein the at least one oil guiding element and the at least one oil passage bore serve to guide oil exiting from the bearing such that it can be supplied in particular ultimately to an oil circuit comprising the rotor arm and preferably also a stator arm and/or to an oil collecting tank. The at least one oil guiding element is therein preferably arranged concentrically with regard to the passage. In particular the oil guiding element is preferably formed as an oil guiding ring.

Particularly preferably, an oil guiding ring that circulates concentrically at a radial distance to the passage is arranged on a side of the supporting element that faces away from the support pot, the inner flank of which oil guiding ring is angled towards the passage. In an annular section of the supporting element that is limited by the oil guidance ring on the one side and the passage on the other side, at least one oil discharge bore is formed, through which oil, which exits from the bearing and is held back by the oil guiding ring, reaches into an interior space of the support pot.

A further oil guiding ring is preferably arranged concentrically and at a radial distance to the passage on a side of the supporting element facing towards the interior space of the support pot, the further oil guiding ring serving for a defined transmission of the oil. For this purpose, the oil guiding ring is formed such that it opens slightly conically towards the interior space of the support pot such that the oil is guided via the centrifugal force of the rotor arm rotating in the operation, directed to an inner peripheral wall of the support pot. From there the oil preferably reaches at least one oil discharge bore that is formed on the outer periphery of the supporting element and aligns with a corresponding opening in the support pot such that the oil exits from the support pot and can be guided back into an oil circuit and/or an oil collection container.

In a further preferred embodiment, the supporting element formed as a supporting disk has at least two, preferably more axial perforations—seen in the radial direction—between the retaining element for the rotation locator and its outer periphery. These are preferably formed to be circular and/or as an elongated hole. It is also possible that all perforations are formed to be circular or as an elongated hole. In another exemplary embodiment it is possible that at least one perforation is formed to be circular, whilst at least one other perforation is formed as an elongated hole. The perforations cause a weight reduction of the supporting element. At the same time they serve as disassembly openings in which special tools can engage. Furthermore it is possible that the perforations act as additional oil discharge or oil passage bores.

Particularly preferably, all holes, perforations and bores provided in the supporting element—seen in the peripheral direction—are distributed evenly or with the same angular distance to one another, in order to achieve a homogenous weight distribution and to prevent imbalances.

It is possible that the at least one oil guiding element and/or the at least one retaining element is/are formed separately from the supporting element and is/are attached to the supporting element. Preferably these elements are, however, formed in one piece with the supporting element and are formed from the material thereof during the production of the supporting element.

Exemplary embodiments are also directed to a method for the production of a supporting element, preferably for the production of a supporting disk. The method involves the preparation of a circular sheet blank or of a forging blank, wherein the circular sheet blank or the forging blank is transformed by means of flow forming (flow forming method) in a front contour of the supporting element. Finally, the front contour is attached to an end contour of the supporting element by means of machining. Therein the machining preferably comprises a rotation, cutting, drilling and/or deburring of the front contour.

Particularly preferably, a forging blank is provided in order to transform the front contour from this by means of flow forming. A blank produced with the aid of a forging or mass forming method has a particularly homogenous, compressed structure, such that not only the blank but also the finished component has an increased mechanical loading capacity. In particular, in the case of mass forming or in the case of forging it is possible to optimally adjust a fiber orientation in the blank with regard to an expected mechanical loading of the finished part. The fiber orientation can be optimized further locally with regard to the expected mechanical loading during flow forming. Therein, it is possible to adjust a discontinuous wall strength varying dependent on location, in particular because fibers can be collected in regions that are high loaded mechanically, such that here a particularly high mechanical loading capacity is produced. Thus it is not necessary to adapt the wall strengths of the parts to be produced overall to a locally expected highest mechanical loading. The production of the supporting element in a forging method connected to the subsequent flow forming thus takes into account the idea of lightweight construction.

A desired firmness of the material can also be adjusted via the degree of transformation and the design of a pre-form of the forging blank.

The production of the front contour in the flow forming method preferably occurs in two to three work steps. Therein, in comparison to other methods, it is possible in the case of flow forming to come very close to the end contour, such that only very little processing is necessary by means of machining. Hereby, it is possible to considerably save material waste, whereby the production costs can be reduced.

Furthermore, the flow forming method in particular enables a one-piece production of the supporting element such that it is not necessary to join several parts to one another. This prevents tolerance-related inaccuracies and thus imbalances, such that overall performance losses of the electrical machine are prevented.

Finally, a method is preferred that is characterized in that the at least one oil guiding element and/or the at least one retaining element is/are formed during flow forming and/or during machining by knife and/or scraper-type insertion tools. Particularly preferably, both all oil guiding elements and the retaining element are formed during flow forming by knife and/or scraper-type tools, wherein these insert into the material and/or strip off material and partially remove the corresponding wall regions as well as subsequently transforming them in the desired manner. Therein, the transformation preferably occurs using or combined with rollers. Particularly preferably, a combined insertion/flow forming method is implemented in order to produce the supporting element and at least one oil guiding element in one piece thereon and/or the at least on retaining element.

### BRIEF DESCRIPTION OF THE DRAWING FIGURES

The invention is illustrated in greater detail below by means of the drawing. Here are shown:

FIG. 1 a three-dimension view of a first side of an exemplary embodiment of a supporting element, and

FIG. 2 a three-dimensional view of a second side of the exemplary embodiment according to FIG. 1.

### DETAILED DESCRIPTION

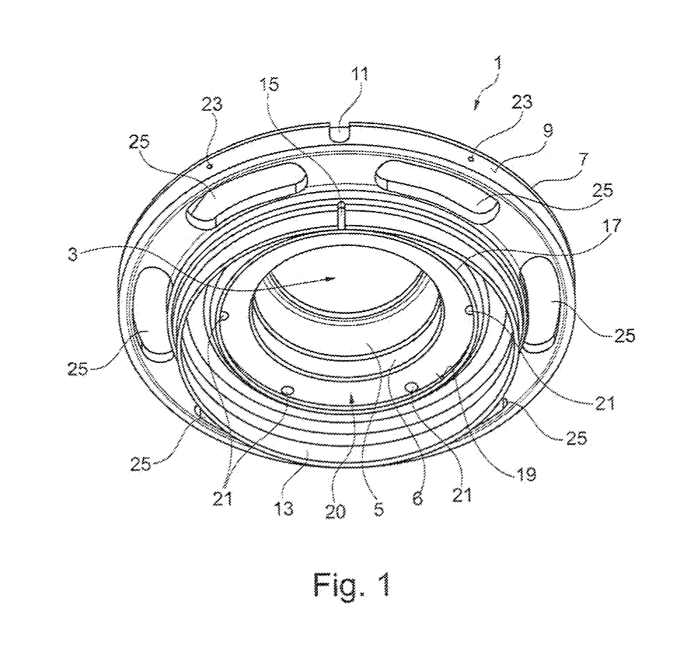

FIG. 1 shows a three-dimensional view of a side of a supporting element 1 formed as a support disk, the side facing away from a hub of a support pot that is not depicted in the assembled state. This has a central passage 3 for the mounting of a drive shaft (not illustrated). The supporting element 1 is arranged in an assembled state on an end of the support pot that faces away from the hub, wherein the passage 3 aligns with the hub.

The passage 3 has a recess 5 on its ends facing away from the hub in the assembled state in which a bearing (not illustrated), preferably a rolling or needle bearing, is arranged, preferably pressed. A further recess 6 is provided axially in front of the recess 5, in which a bearing (not illustrated), preferably a rolling or needle bearing, is arranged, preferably pressed, in the supporting element 1 for mounting the clutch.

With its outer periphery 7, the supporting element 1 abuts onto an end stop formed as a recess, of the support top in the assembled state. A receiving recess 11 is introduced into an outer peripheral surface 9 of the supporting element 1, the receiving recess 11 here being formed as a groove extending in the axial direction. It serves for fixing the supporting element 1 on the support pot in a predetermined relative position—seen in the peripheral direction. For this purpose, a securing means, for example a pin or a screw, engages in the receiving recess 11 through a through bore provided in an outer peripheral wall of the support pot. It is possible that in another exemplary embodiment of the supporting element 1, more than one receiving recess 11 are provided.

A retaining element 13 is provided concentrically to the passage 3, however at a radial distance to this, which is formed here as a circulating, axially protruding coil. A preferably inductively acting rotation locator is able to be inserted on the retaining element 13. The retaining element 13 has a fixing means 15 for the non-rotatable positioning of the rotation locator relative to the securing element 1 and is formed here as a slot, which extends in the axial direction. A blocking element of the rotation locator is able to be inserted into this.

A first oil guiding element 17 is arranged concentrically to the passage 3 and—seen in the radial direction—between this and the retaining element 13. This is formed here as a circulating oil guiding ring or oil barrier—seen in the peripheral direction —, the inner flank 19 of which is angled towards the passage 3. Preferably the entire first oil guiding element 17 can be formed slightly conically wherein it is angled towards the passage 3. It acts as an oil blocking element because oil exiting from the bearing that is not depicted here into the recess 5 is held by it and thus virtually collected in an annular region 20 between the bearing and the first oil guiding element 17.

In this annular region 20, oil passage bores 21 are formed through which the oil that is being collected by the side of the supporting element 1 that is facing towards the observer in FIG. 1 can flow on the side facing away from the observer. The oil passage bores 21 are therefore formed as through bores. In particular it is therefore possible that oil reaches from the side of the supporting element 1 facing away from the hub and thus an interior space of the support pot to a side facing towards the interior space and thus in the interior space of the support pot.

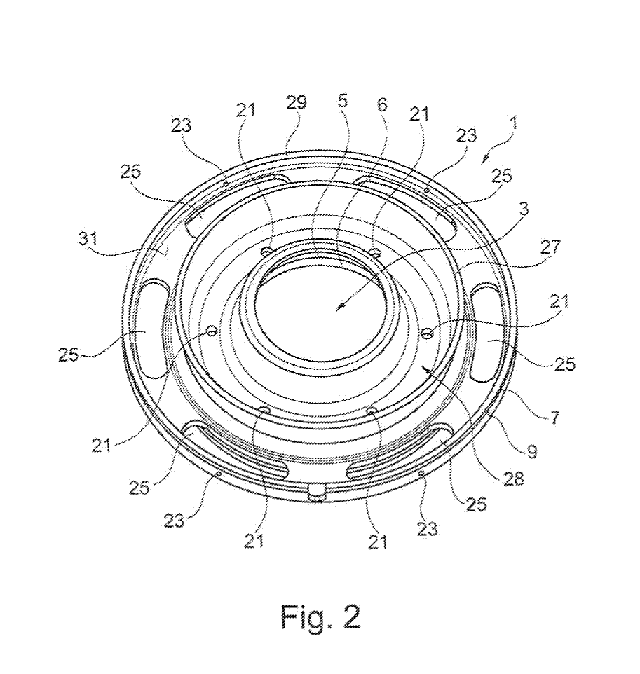

Further oil passage bores 23 are depicted in FIG. 1, which are introduced into the outer peripheral surface 9. The function thereof will be explained in connection with FIG. 2.

Furthermore, it is also depicted in FIG. 1 that perforations 25 are arranged between the outer peripheral surface 9 and the retaining element 13. These are formed here as elongated holes. Alternatively it is possible that the perforations are formed as bores, in particular circular bores. They serve on the one hand for a weight reduction of the supporting element 1 and on the other hand as a disassembly opening, in particular for the insertion of special tools. If necessary it is also possible that the perforations 25 act as additional oil passage bores.

Due to FIG. 1 it is clear that all perforations, holes and/or bores—seen in the peripheral direction, are evenly distributed, in particular are distributed at the same angular distance to one another. Hereby it is possible to ensure a homogenous weight distribution of the supporting element 1 and to prevent imbalances.

FIG. 2 shows a three-dimensional view of a side of the supporting element 1 according to FIG. 1 facing away from the interior space or the hub of the support pot. The same elements and elements with the same function are provided with the same reference numerals, so as to reference the preceding description in this respect. A second oil guiding element 27 is arranged here between the passage 3 and the outer peripheral surface 9—seen in the radial direction—approximately at the height of the first oil guiding element 17. This is likewise formed as an oil guiding ring circulating concentrically to the passage 3, however at a radial distance to this. However, the second oil guiding element 27 is formed slightly conically with the cone angle opening to the interior space of the support pot. It is also recognizable that the oil passage bores 21 flow into an annular region 28 between the passage 3 and the second oil guiding element 27. Oil, which is collected here, is forced against the second oil guiding element 27 by the centrifugal force in the case of a rotating rotor arm, where it, due to the opening angle of this, experiences a downward force towards the interior space of the support pot. It is therefore transmitted definedly into the interior of the support pot. There it finally reaches an inner peripheral surface of the support pot, and via this a determined oil proportion reaches the oil passage bores 23 that perforate the outer peripheral surface 9. It is shown that the supporting element 1 has a collar 29 in the region of its outer periphery 7, which projects—seen in the axial direction—towards the interior space of the support pot via a surface 31 of the supporting element 1 such that oil that has been accelerated by the centrifugal force is collected behind the collar 29 and can finally discharge through the oil passage bores 23.

The oil passage bores 23 align with corresponding through bores in the outer peripheral wall of the support pot, such that oil ultimately can exit from the support pot and be supplied to an oil supply system and/or and oil collection tank.

The support pot that is not depicted here is preferably formed substantially as a conventional rotor arm, with the difference that it is provided with functional elements described here in order to receive the supporting element 1 or to work with this. Furthermore, in the case of a conventional rotor arm, the support pot is ultimately identical to the rotor arm. The rotor arm according to the invention comprises, on the other hand, the support pot and the supporting element 1. It is possible that the rotor arm comprises further elements. For example, an additional supporting element, preferably a cover plate for the further mounting of the drive shaft, can be comprised of the rotor arm. Preferably it is provided that the supporting element 1 formed as a supporting disk covers the support pot on its side facing away from the hub virtually as a cover. If an additional supporting element formed in particular as a cover plate is provided, the supporting element 1 preferably formed as a supporting disk is arranged virtually as an intermediate support in the support pot. Overall, an advantageous support of the one-piece or several-piece drive shaft results on both sides of the rotor arm whereby imbalances and performance loss connect hereto of the electrical machine can be prevented.

Thus, overall it is shown that, using the rotor arm, the supporting element and the method for the production of a supporting element, performance losses and in particular also a series dispersion of electrical machines can be clearly reduced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A rotor arm for an electrical machine having a support pot for mounting at least one magnetic element, wherein the support pot has a hub for mounting a drive shaft, wherein the rotor arm comprises:
a support disk, arranged on the support pot at a distance axially from the hub, wherein the support disk has a passage aligned with the hub, wherein the passage is configured for mounting the drive shaft.

12. The rotor arm of claim 11, further comprising:
a rolling bearing mounted in the passage by pressing the rolling bearing into the passage.

13. The rotor arm of claim 11, wherein the support disk is arranged on an end of the support pot facing away from the hub.

14. The rotor arm of claim 11, wherein the support pot has an end stop for the support disk on an inner peripheral surface, wherein the end stop is a recess.

15. A support disk for a rotor arm for an electrical machine having a support pot for mounting at least one magnetic element, wherein the support pot has a hub for mounting a drive shaft, wherein
the support disk is arranged on the support pot at a distance axially from the hub, the support disk has a passage aligned with the hub, and
the passage is configured for mounting the drive shaft.

16. The support disk of claim 15, wherein a peripheral surface of the support disk includes a receiving recess configured for non-rotatable fixing of the support disk to the support pot.

17. The support disk of claim 15, further comprising:
at least one retaining element configured to receive a rotation locator, wherein the retaining element has a fixing element for the non-rotatable positioning of the rotation locator.

18. The support disk of claim 15, further comprising:
at least one oil guiding element arranged concentrically to the passage; and
at least one oil passage bore configured to guide oil exiting from the bearing.

19. A method for the production of a support disk, the method comprising:
providing a circular sheet blank or a forging blank;
transforming the circular sheet blank or the forging blank by flow forming in a front contour of the support disk; and
attaching the front contour to an end contour of the support disk by machining.

20. The method of claim 19, wherein at least one oil guiding element or at least one retaining element is formed during flow forming or during machining using knife or scraper-type insertion tools.
